(19) United States
(12) Patent Application Publication
(10) Pub. No.: US 2008/0018518 A1
(43) Pub. Date: Jan. 24, 2008

(54) Remote system capable of controlling an electronic device and method thereof

(75) Inventors: Chun-Kai Chan, (US); Li-Hsiang Liao, (US); Ya-Shu Juang, (US)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/826,961

(22) Filed: Jul. 19, 2007

(30) Foreign Application Priority Data
Jul. 21, 2006 (TW) 095126787

(51) Int. Cl. H04L 17/02

(52) U.S. Cl. 341/176

(57) ABSTRACT

A method for controlling an electronic device including at least one working mode includes receiving an input signal, determining whether the input signal is a switch signal, and determining whether the input signal is a function signal. When the input signal is the switch signal, the working mode of the electronic device will be changed into another working mode. When the input signal is the function signal, a function corresponding to the function signal will be executed.

### BACKGROUND OF THE INVENTION

1. Field of the Invention

The present invention relates to a remote system for controlling an electronic device and a method thereof, and more specifically, to a remote system capable of controlling an electronic device at different working modes and a method thereof.

2. Description of the Prior Art

With the development of new technology, electronic devices used widely in daily life, such as TV, a video recorder, and/or so on, have gained more and more functions. That is to say, control interfaces for controlling the electronic devices also have gained more and more complicated operations. A remote controller is the most representative example. Because the remote controller is used to control all functions of the corresponding electronic device, there are many function keys set on the remote controller.

Please refer to FIG. 1. FIG. 1 is a functional block diagram of a remote controller 10 according to the prior art. The remote controller 10 comprises an input interface 12, firmware 14, a decoder 16, and a wireless module 18. The input interface 12 comprises a plurality of function keys for generating a function signal corresponding to a function key pressed by a user. The firmware 14 is coupled to the decoder 16 for initializing the decoder 16. The decoder 16 is coupled to the input interface 12 for receiving and decompiling the function signal generated by the input interface 12, and for controlling the wireless module 18 to transmit a wireless signal corresponding to the function signal to an electronic device 20 after the function signal has been decompiled by the decoder 16. When the electronic device 20 receives the wireless signal, the electronic device 20 will execute a function corresponding to the function signal, such as channel switching, volume adjusting, and so on, after decompiling the wireless signal to the function signal. In such a manner, each function key on the input interface 12 can only correspond to a function. That is to say, a relation between the function key and the function is one-to-one. However, the one-to-one relation between the function key and the function results in numerous function keys being set on the remote controller 10. Therefore, not only are the operations of the remote controller 10 difficult, but also the size of the remote controller 10 can not be reduced because of the numerous keys.

### SUMMARY OF THE INVENTION

The present invention discloses a method for controlling an electronic device having at least one working mode comprising receiving an input signal, determining whether the input signal is a switch signal, wherein the working mode of the electronic device will be changed when the input signal is the switch signal, and determining whether the input signal is a function signal, wherein a function corresponding to the function signal will be executed when the input signal is the function signal.

The present invention further discloses a remote system comprising a remote controller comprising a mode-switching interface for generating a switch signal, a function-controlling interface for generating a function signal, and a first wireless module coupled to the mode-switching interface and the function-controlling interface, for transmitting wireless signals corresponding to the switch signal and the function signal, and an electronic device comprising a second wireless module for receiving the wireless signals corresponding to the switch signal and the function signal, a memory module comprising a key table for saving a relation between the switch signal and the function signal, and a processor for changing a working mode of the electronic device based on the key table and the switch signal or for executing a function of the working mode based on the key table and the function signal.

The present invention further discloses a remote system comprising a remote controller comprising a mode-switching interface for generating a switch signal, a function-controlling interface for generating a function signal, and a memory module comprising a key table for saving a relation of the switch signal and the function signal, a first wireless module coupled to the mode-switching interface and the function-controlling interface, for transmitting a corresponding signal based on the key table, and an electronic device comprising a second wireless module for receiving the corresponding signal, and a processor for changing a working mode of the electronic device when the corresponding signal is the switch signal and for executing a function of the working mode when the corresponding signal is the function signal. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a remote controller according to the prior art.

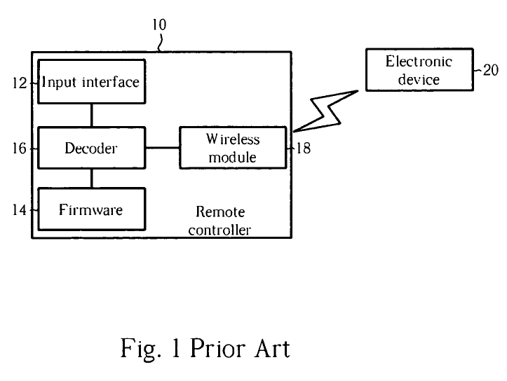

FIG. 2 is a functional block diagram of a remote system according to a first embodiment of the present invention.

FIG. 3 is a diagram of the remote system in FIG. 2.

FIG. 4 is a flowchart of a method for controlling the electronic device having at least one working mode in the remote system in FIG. 3.

FIG. 5 is a functional block diagram of a remote system according to a second embodiment of the present invention.

### DETAILED DESCRIPTION

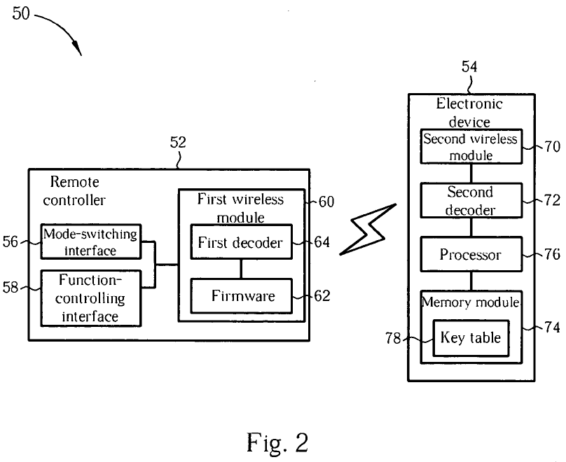

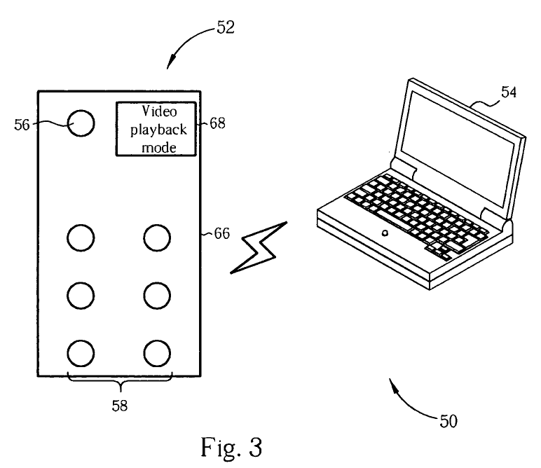

Please refer to FIG. 2 and FIG. 3. FIG. 2 is a functional block diagram of a remote system 50 according to a first embodiment of the present invention. FIG. 3 is a diagram of the remote system 50 according to the first embodiment of the present invention. Please refer to FIG. 2 first. The remote system 50 comprises a remote controller 52 and an electronic device 54. The remote controller 52 comprises a mode-switching interface 56 (please refer to FIG. 3 at the same time), a function-controlling interface 58 (please refer to FIG. 3 at the same time), and a first wireless module 60. The mode-switching interface 56 is used for generating a switch signal. The function-controlling interface 58 is used for generating a function signal. The first wireless module 60 comprises firmware 62 and a first decoder 64. The first wireless module 60 is coupled to the mode-switching interface 56 and the function-controlling interface 58 separately for transmitting wireless signals corresponding to the switch signal and the function signal. The firmware 62 is used for initializing the first decoder 64. The first decoder 64 is used for decompiling the switch signal generated by the mode-switching interface 56 or the function signal generated by the function-controlling interface 58. Then, the wireless module 60 transmits a wireless signal corresponding to the decompiled switch signal or the decompiled function signal to the electronic device 54.

Please refer to FIG. 2 again. The electronic device 54 can be a notebook. The electronic device 54 comprises a second wireless module 70, a second decoder 72, a memory module 74, and a processor 76. The second wireless module 70 is used for receiving the wireless signal transmitted by the first wireless module 60. The memory module 74 comprises a key table 78. The key table 78 is used for saving a relation between the switch signal and the function signal. The processor 76 changes a working mode of the electronic device 54 based on the key table 78 if the wireless signal is decompiled to the switch signal by the second decoder 72. For example, the processor 76 changes the working mode of the electronic device 54 from a video playback mode to a report playback mode. Likewise the processor 76 executes a function of the working mode based on the key table 78 if the wireless signal is decompiled to the function signal by the second decoder 72. For example, the processor 76 can execute a forward function in the video playback mode, or a page-up function in the report playback mode. In addition, a number of function options is not limited by the key table 78, but instead depends on the capacity of the memory module 74. In such a manner, the present invention can utilize few function keys and the key table 78 to control more functions on the electronic device 54.

Please refer to FIG. 3. The remote controller 52 further comprises a case 66 and a display device 68 installed on the case 66. The display device 68 can be an LED (light emitting diode) screen or an LCD (liquid crystal display) screen. The display device 68 is used for displaying information about the working mode or the function of the electronic device 54. For example, when the working mode is a video playback mode, the display device 68 displays ‘video playback mode’.

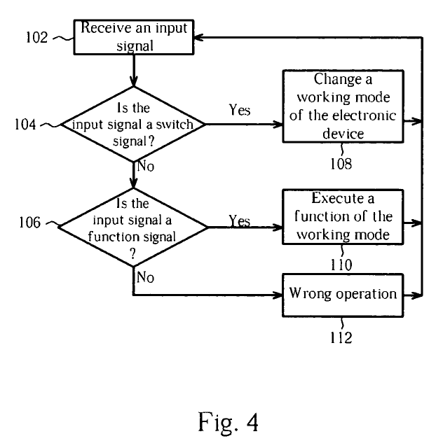

Please refer to FIG. 4. FIG. 4 is a flowchart of a method for controlling the electronic device 54 having at least one working mode in the remote system 50 according to the present invention. The method comprises the following steps.

Step 102: The remote controller 52 receives an input signal when a user operates the mode-switching interface 56 or the function-controlling interface 58;

Step 104: Determine whether the input signal is a switch signal. If so, go to Step 108. If not, go to Step 106;

Step 106: Determine whether the input signal is a function signal. If so, go to Step 110. If not, go to Step 112;

Step 108: Change a working mode of the electronic device 54 according to the switch signal;

Step 110: Control the electronic device 54 to execute a function of the working mode according to the function signal;

Step 112: Wrong operation. Go back to Step 102.

The mode-switching interface 56 mentioned in Step 102 can be a mode-switching key. The function-controlling interface 58 mentioned in Step 102 can be a plurality of function-controlling keys having corresponding instruction icons respectively. Furthermore, a relation between the switch signal and the function signal can be predetermined by the key table 78 or be set by the user. The wrong operation mentioned in Step 112 means that the user operates the remote controller 52 incorrectly. For example, if the user presses the undefined function key, the remote controller 52 will be in a stand-by state and not generate a wireless signal to control the electronic device 54 until the user operates the remote controller 52 correctly.

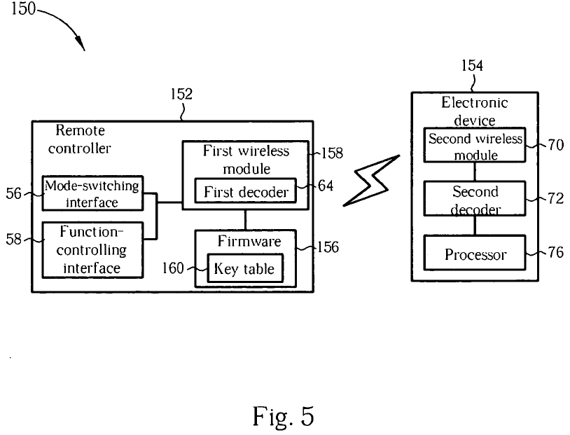

Please refer to FIG. 5. FIG. 5 is a functional block diagram of a remote system 150 according to a second embodiment of the present invention. Differences between the remote system 50 and the remote system 150 are a position of the key table and a processing flow of the input signal. Components mentioned in both the first and the second embodiments represent components with similar functions. The remote system 150 comprises a remote controller 152 and an electronic device 154. The remote controller 152 comprises firmware 156, the mode-switching interface 56, the function-controlling interface 58, and a first wireless module 158. The electronic device 154 comprises the second wireless module 70, the second decoder 72, and the processor 76. The firmware 156 comprises a key table 160. The first wireless module 158 comprises the first decoder 64 for receiving an input signal generated by the mode-switching interface 56 or the function-controlling interface 58 and decompiled by the first decoder 64, and for transmitting a corresponding wireless signal to the electronic device 154 based on a relation between a switch signal and a control signal saved by the key table 160. The second wireless module 70 is used for receiving the corresponding wireless signal transmitted from the wireless module 158. After the wireless signal is decompiled by the second decoder 72, the processor 76 controls the electronic device 154 based on the decompiled wireless signal. In other words, if the wireless signal is decompiled to a switch signal by the second decoder 72, the processor 76 changes a working mode of the electronic device 154 according to the switch signal. If the wireless signal is decompiled to a function signal by the second decoder 72, the processor 76 executes a function of the current working mode according to the function signal.

The remote systems and the method thereof according to the present invention utilize relations between switch signals and function signals predetermined by a key table or set by a user to change the one-to-one relation between the function key and the function mentioned in the prior art into a one-to-many relation. In such a manner, both a number of keys set on a remote controller and the size of the remote controller can be reduced.

Those skilled in the art will readily observe that numerous modifications and alterations of the device and method may be made while retaining the teachings of the invention.

What is claimed is:

1. A method for controlling an electronic device having at least one working mode comprising:
receiving an input signal;
determining whether the input signal is a switch signal, wherein the working mode of the electronic device will be changed when the input signal is the switch signal; and
determining whether the input signal is a function signal, wherein a function corresponding to the function signal will be executed when the input signal is the function signal.

2. A remote system comprising:
a remote controller comprising:
a mode-switching interface for generating a switch signal;
a function-controlling interface for generating a function signal; and
a first wireless module coupled to the mode-switching interface and the function-controlling interface, for transmitting wireless signals corresponding to the switch signal and the function signal; and
an electronic device comprising:
a second wireless module for receiving the wireless signals corresponding to the switch signal and the function signal;
a memory module comprising a key table for saving a relation between the switch signal and the function signal; and
a processor for changing a working mode of the electronic device based on the key table and the switch signal or for executing a function of the working mode based on the key table and the function signal.

3. The remote system of claim 2, wherein the first wireless module comprises a first decoder for decompiling the switch signal or the function signal.

4. The remote system of claim 3, wherein the first wireless module further comprises a firmware for initializing the first decoder.

5. The remote system of claim 2, wherein the electronic device further comprises a second decoder for decompiling the wireless signals corresponding to the switch signal and the function signal.

6. The remote system of claim 2, wherein the working mode is a video playback mode.

7. The remote system of claim 2, wherein the working mode is a report playback mode.

8. The remote system of claim 2, wherein the remote controller further comprises a case, and a display device installed on the case for displaying information of the working mode or the function.

9. The remote system of claim 8, wherein the display device is an LED (light emitting diode) screen or an LCD (liquid crystal display) screen.

10. The remote system of claim 2, wherein the electronic device is a notebook.

11. The remote system of claim 2, wherein the mode-switching interface is a mode-switching key.

12. The remote system of claim 2, wherein the function-controlling interface is a plurality of function-controlling keys.

13. The remote system of claim 12, wherein the plurality of function-controlling keys have corresponding instruction icons respectively.

14. A remote system comprising:
a remote controller comprising:
a mode-switching interface for generating a switch signal;
a function-controlling interface for generating a function signal; and
a memory module comprising a key table for saving a relation between the switch signal and the function signal;
a first wireless module coupled to the mode-switching interface and the function-controlling interface, for transmitting a corresponding signal based on the key table; and
an electronic device comprising:
a second wireless module for receiving the corresponding signal; and
a processor for changing a working mode of the electronic device when the corresponding signal is the switch signal and for executing a function of the working mode when the corresponding signal is the function signal.

15. The remote system of claim 14, wherein the first wireless module comprises a first decoder for decompiling the switch signal or the function signal.

16. The remote system of claim 15, wherein the memory module comprises a firmware for initializing the first decoder.

17. The remote system of claim 14, wherein the electronic device further comprises a second decoder for decompiling the corresponding signal.

18. The remote system of claim 14, wherein the working mode is a video playback mode.

19. The remote system of claim 14, wherein the working mode is a report playback mode.
